(19) United States
(12) Patent Application Publication
(10) Pub. No.: US 2013/0262721 A1
(43) Pub. Date: Oct. 3, 2013

(54) CONNECTION SYSTEM WITH KEYBOARD-VIDEO-MOUSE DEVICE

(71) Applicant: ZHENG-XIN GAO, Shenzhen City (CN)

(72) Inventor: ZHENG-XIN GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,280

(22) Filed: Aug. 29, 2012

(30) Foreign Application Priority Data
Apr. 3, 2012 (CN) 201210095701.9

(51) Int. Cl. G06F 13/12

(52) U.S. Cl. 710/63

(57) ABSTRACT

A connection system includes a keyboard-video-mouse (KVM) device, first and second electronic devices, first and second cables. The first cable includes a first terminal connected to the KVM device, a second terminal connected to the first electronic device, and a first indicator positioned on the first cable and close to the second terminal. The second cable includes a third terminal connected to the KVM device, a fourth terminal connected to the second electronic device, and a second indicator positioned on the second cable and close to the fourth terminal. The KVM device includes first to third switches, and a logic circuit connected to the first to third switches and the first and second indicators. When the first and second switches are closed, the first indicator is lit by the logic circuit. When the first and third switches are closed, the second indicator is lit by the logic circuit.

### BACKGROUND

1. Technical Field

The present disclosure relates to connection systems, and more particularly to a connection system including a keyboard-video-mouse (KVM) device.

2. Description of Related Art

A KVM device allows users using a keyboard, a video monitor, and a mouse to control a plurality of electronic devices, such as computer, by transmitting signals between the keyboard, the video monitor, the mouse, and the electronic devices. However, each electronic device is connected to a power supply, a network, etc, besides the KVM device. Therefore, there is a plurality of cables in the system. Finding a desired cable in the system may be tedious and time consuming.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a connection system in accordance with an exemplary embodiment of the present disclosure, wherein the connection system includes a logic circuit.

FIG. 2 is a circuit diagram of the logic circuit of FIG. 1 in accordance with a first embodiment.

FIG. 3 is a circuit diagram of the logic circuit of FIG. 1 in accordance with a second embodiment.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

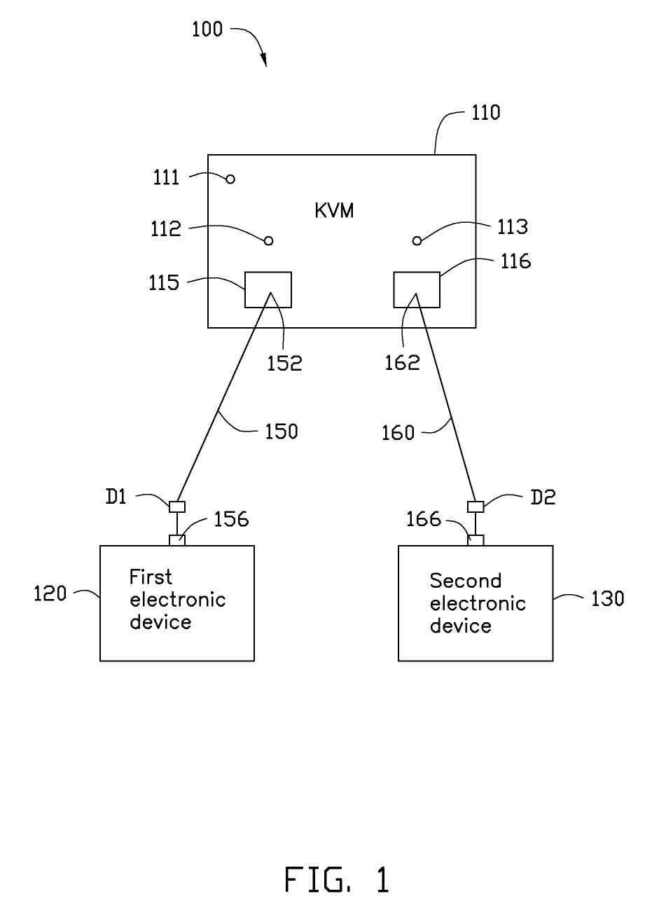

Referring to FIG. 1, an exemplary embodiment of a connection system 100 is shown. The connection system 100 includes a keyboard-video-mouse (KVM) device 110, a first electronic device 120, a second electronic device 130, a first cable 150 used to connecting the KVM device 110 and the first electronic device 120, and a second cable 160 used to connecting the KVM device 110 and the second electronic device 130. In one embodiment, each the first electronic device 120 and the second electronic device 130 may be a computer. The connection system 100 may further includes other cables, such as power cables and network cables. These other cables fall within well-known technologies, and are therefore not described here.

The KVM device 110 includes a first switch 111, a second switch 112, a third switch 113, a first interface 115, a second interface 116, and a logic circuit. Further details of the logic circuit will be explained in further detail below. The first cable 150 includes a first terminal 152, a second terminal 156, and an indicator D1. The first terminal 152 is connected to the first interface 115. The second terminal 156 is connected to a corresponding interface of the first electronic device 120. The indicator D1 is positioned on the first cable 150 and close to the second terminal 156. The second cable 160 includes a first terminal 162, a second terminal 166, and an indicator D2. The first terminal 162 is connected to the second interface 116. The second terminal 166 is connected to a corresponding interface of the second electronic device 130. The indicator D2 is positioned on the second cable 160 and close to the second terminal 166. The second switch 112 aligns with the first interface 115. The third switch 113 aligns with the second interface 116. In one embodiment, the second switch 112 aligns with the first interface 115 and above the first interface 115. The third switch 113 aligns with the second interface 116 and above the second interface 116.

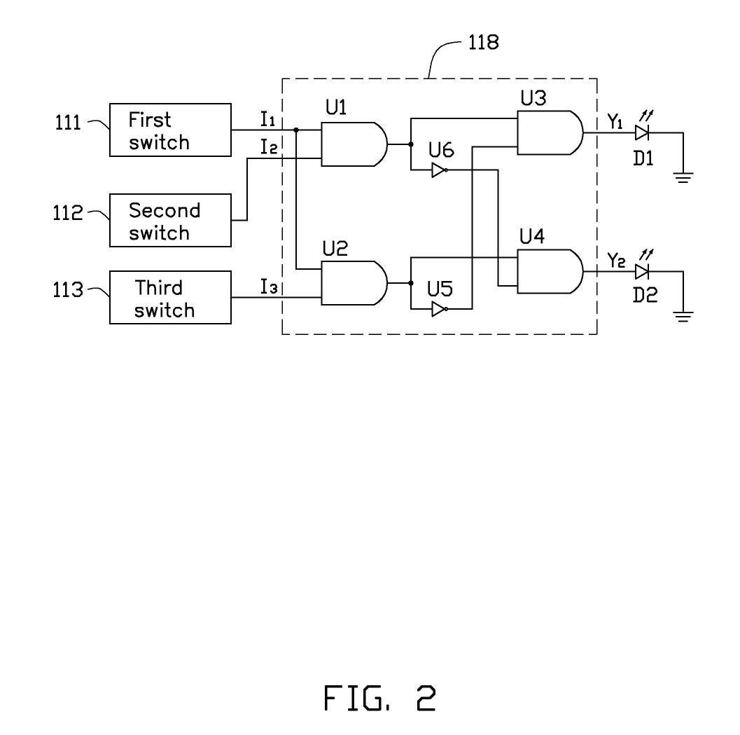

Referring to FIG. 2, a first embodiment of a logic circuit 118 of the KVM device 110 includes a first AND gate U1, a second AND gate U2, a third AND gate U3, a fourth AND gate U4, a first NOT gate U5, and a second NOT gate U6. A first input terminal of the first AND gate U1 functions as a first input terminal of the logic circuit 118, and is connected to the first switch 111. A second input terminal of the first AND gate U1 functions as a second input terminal of the logic circuit 118, and is connected to the second switch 112. A first input terminal of the second AND gate U2 is connected to the first input terminal of the first AND gate U1. A second input terminal of the second AND gate U2 functions as a third input terminal of the logic circuit 118, and is connected to the third switch 113. A first input terminal of the third AND gate U3 is connected to an output terminal of the first AND gate U1. A second input terminal of the third AND gate U3 is connected to an output terminal of the first NOT gate U5. An input terminal of the first NOT gate U5 is connected to an output terminal of the second AND gate U2. A first input terminal of the fourth AND gate U4 is connected to the output terminal of the second AND gate U2. A second input terminal of the fourth AND gate U4 is connected to an output terminal of the second NOT gate U6. An input terminal of the second NOT gate U6 is connected to the output terminal of the first AND gate U1. An output terminal of the third AND gate U3 functions as a first output terminal of the logic circuit 118, and is connected to a first terminal of the indicator D1. A second terminal of the indicator D1 is grounded. An output terminal of the fourth AND gate U4 functions as a second output terminal of the logic circuit 118, and is connected to a first terminal of the indicator D2. A second terminal of the indicator D2 is grounded.

The first input terminal of the logic circuit 118 receives a signal I₁ from the first switch 111. The second input terminal of the logic circuit 118 receives a signal I₂ from the second switch 112. The third input terminal of the logic circuit 118 receives a signal I₃ from the third switch 113. The first output terminal of the logic circuit 118 outputs a signal Y₁ to the first terminal of the indicator D1. The second output terminal of the logic circuit 118 outputs a signal Y₂ to the first terminal of the indicator D2. The relationship of the signals I₁, I₂, I₃, and Y₁ is Y₁=I₁I₂ I̅₁̅I̅₃̅=I₁I₂( I̅₁̅+ I̅₃̅)=I₁I₂ I̅₃̅. The relationship of the signals I₁, I₂, I₃, and Y₂ is Y₂=I₁I₃ I̅₁̅I̅₂̅=I₁I₃( I̅₁̅+ I̅₂̅)=I₁I₃ I̅₂̅.

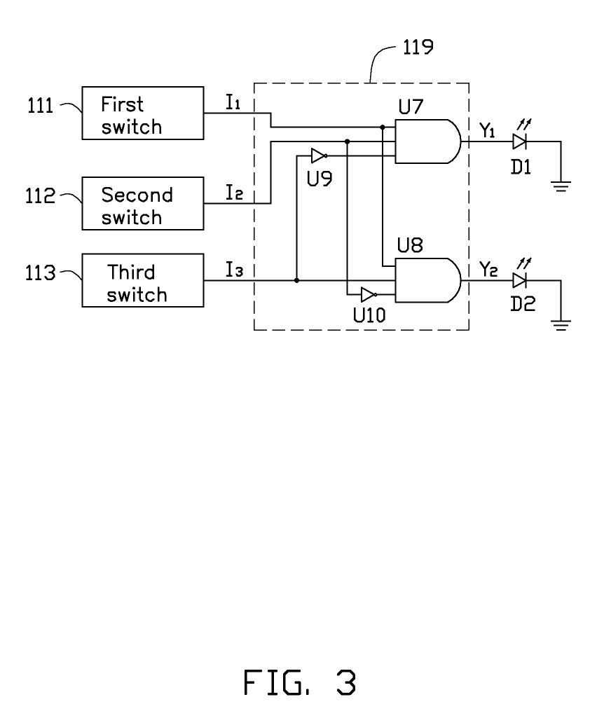

Referring to FIG. 3, a second embodiment of a logic circuit 119 of the KVM device 110 includes a first AND gate U7, a second AND gate U8, a first NOT gate U9, and a second NOT gate U10. A first input terminal of the first AND gate U7 functions as a first input terminal of the logic circuit 119, and is connected to the first switch 111. A second input terminal of the first AND gate U7 functions as a second input terminal of the logic circuit 119, and is connected to the second switch 112. A third input terminal of the first AND gate U7 is connected to an output terminal of the first NOT gate U9. A first input terminal of the second AND gate U8 is connected to the first input terminal of the first AND gate U7. A second input terminal of the second AND gate U8 functions as a third input terminal of the logic circuit 119, and is connected to the third switch 113. A third input terminal of the second AND gate U8 is connected to an output terminal of the second NOT gate U10. An input terminal of the first NOT gate U9 is connected to the second input terminal of the second AND gate U8. An input terminal of the second NOT gate U10 is connected to the second input terminal of the first AND gate U7. An output terminal of the first AND gate U7 functions as a first input terminal of the logic circuit 119, and is connected to a first terminal of the indicator D1. A second terminal of the indicator D1 is grounded. An output terminal of the second AND gate U8 functions as a second output terminal of the logic circuit 119, and is connected to a first terminal of the indicator D2. A second terminal of the indicator D2 is grounded.

The first input terminal of the logic circuit 119 receives a signal I₁ from the first switch 111. The second input terminal of the logic circuit 119 receives a signal I₂ from the second switch 112. The third input terminal of the logic circuit 119 receives a signal I₃ from the third switch 113. The first output terminal of the logic circuit 119 outputs a signal Y₁ to the first terminal of the indicator D1. The second output terminal of the logic circuit 119 outputs a signal Y₂ to the first terminal of the indicator D2. The relationship of the signals I₁, I₂, I₃, and Y₁ is Y₁=I₁I₂ I̅₃̅. The relationship of the signals I₁, I₂, I₃, and Y₂ is Y₂=I₁I₃ I̅₂̅.

It may be understood that, the logic circuit of the KVM device 110 is illustrated by the above two embodiments in present disclosure, but not limited by the above two embodiments. A logic circuit achieving function of Y₁=I₁I₂ I̅₃̅ and Y₂=I₁I₃ I̅₂̅, may be composed of logic elements in other combinations, and the other combinations of logic elements are not described here.

When the connection system 100 is under maintenance, and an operator wants to disconnect the second terminal 156 of the first cable 150 from the first electronic device 120, the first switch 111 and the second switch 112 are closed. The signal I₁ received by the first input terminal of the logic circuit from the first switch 111 has a high level, such as logic 1. The signal I₂ received by the second input terminal of the logic circuit from the second switch 112 has a high level. The signal I₃ received by the third input terminal of the logic circuit from the third switch 113 has a low level, such as logic 0. The signal Y₁=I₁I₂ I̅₃̅ output by the first output terminal of the logic circuit is at a high level and is output to the first terminal of the indicator D1, to light the indicator D1. The signal Y₂=I₁I₃ I̅₂̅ output by the second output terminal of the logic circuit is at a low level and is output to the first terminal of the indicator D2, which cannot light the indicator D2. The operator can find the first cable 150 from the cables of the connection system 100 according to the luminous indicator D1, and disconnect the second terminal 156 of the first cable 150 from the first electronic device 120.

When the operator wants to disconnect the second terminal 166 of the second cable 160 from the second electronic device 130, the first switch 111 and the third switch 113 are closed. The signal I₁ received by the first input terminal of the logic circuit from the first switch 111 has a high level. The signal I₂ received by the second input terminal of the logic circuit from the second switch 112 has a low level. The signal I₃ received by the third input terminal of the logic circuit from the third switch 113 has a high level. The signal Y₁=I₁I₂ I̅₃̅ output by the first output terminal of the logic circuit is at a low level and is output to the first terminal of the indicator D1, which cannot light the indicator D1. The signal Y₂=I₁I₃ I̅₂̅ output by the second output terminal of the logic circuit is at a high level and is output to the first terminal of the indicator D2, to light the indicator D2. The operator can find the second cable 160 from the cables of the connection system 100 according to the luminous indicator D2, and disconnect the second terminal 166 of the second cable 160 from the second electronic device 130.

In one embodiment, each of the indicators D1 and D2 is a light-emitting diode (LED). The first and second terminals of each of the indicators D1 and D2 are an anode and a cathode of the LED, respectively. In other embodiments, the number of the electronic devices and the cables included in the connection system 100, the number of the switches and the interfaces included in the KVM device 110, the number of the input terminals and the output terminals of the logic circuit, and logic elements and combinations of logic elements of the logic circuit, can be adjusted according to actual need.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A connection system, comprising:
a first electronic device and a second electronic device;
a first cable comprising a first terminal, a second terminal connected to the first electronic device, and a first indicator positioned on the first cable and close to the second terminal;
a second cable comprising a third terminal, a fourth terminal connected to the second electronic device, and a second indicator positioned on the second cable and close to the fourth terminal of the second cable; and
a keyboard-video-mouse (KVM) device comprising:
a first switch, a second switch, and a third switch;
a first interface connected to the first terminal of the first cable;
a second interface connected to the third terminal of the second cable; and
a logic circuit comprising:
a first input terminal connected to the first switch;
a second input terminal connected to the second switch;
a third input terminal connected to the third switch;
a first output terminal connected to the first indicator; and
a second output terminal connected to the second indicator;
wherein the first indicator is lit by the logic circuit, and the second indicator is not lit by the logic circuit, in response to the first and second switches being closed and the third switch being open; and
wherein the first indicator is not lit by the logic circuit, and the second indicator is lit by the logic circuit, in response to the first and third switches being closed and the second switch being open.

2. The connection system of claim 1, wherein the first input terminal of the logic circuit receives a signal I₁ from the first switch, the second input terminal of the logic circuit receives a signal I₂ from the second switch, the third input terminal of the logic circuit receives a signal I₃ from the third switch, the first output terminal of the logic circuit outputs a signal Y₁ to the first indicator, and the second output terminal of the logic circuit outputs a signal Y₂ to the second indicator; the relationship of the signals I₁, I₂, I₃, and Y₁ is Y₁=I₁I₂ I̅₃̅, and the relationship of the signals I₁, I₂, I₃, and Y₂ is Y₂=I₁I₃ I̅₂̅.

3. The connection system of claim 2, wherein the logic circuit further comprises:
a first AND gate comprising a first input terminal functioning as the first input terminal of the logic circuit, a second input terminal functioning as the second input terminal of the logic circuit, and an output terminal;
a second AND gate comprising a first input terminal connected to the first input terminal of the first AND gate, a second input terminal functioning as the third input terminal of the logic circuit, and an output terminal;
a third AND gate comprising a first input terminal connected to the output terminal of the first AND gate, a second input terminal, and an output terminal functioning as the first output terminal of the logic circuit;
a fourth AND gate comprising a first input terminal connected to the output terminal of the second AND gate, a second input terminal, and an output terminal functioning as the second output terminal of the logic circuit;
a first NOT gate comprising an input terminal connected to the output terminal of the second AND gate, and an output terminal connected to the second input terminal of the third AND gate; and
a second NOT gate comprising an input terminal connected to the output terminal of the first AND gate, and an output terminal connected to the second input terminal of the fourth AND gate.

4. The connection system of claim 2, wherein the logic circuit further comprises:
a first AND gate comprising a first input terminal functioning as the first input terminal of the logic circuit, a second input terminal functioning as the second input terminal of the logic circuit, a third input terminal, and an output terminal functioning as the first output terminal of the logic circuit;
a second AND gate comprising a first input terminal connected to the first input terminal of the first AND gate, a second input terminal functioning as the third input terminal of the logic circuit, a third input terminal, and an output terminal functioning as the second output terminal of the logic circuit;
a first NOT gate comprising an input terminal connected to the second input terminal of the second AND gate, and an output terminal connected to the third input terminal of the first AND gate; and
a second NOT gate comprising an input terminal connected to the second input terminal of the first AND gate, and an output terminal connected to the third input terminal of the second AND gate.

5. The connection system of claim 1, wherein the first indicator comprises a first terminal connected to the first output terminal of the logic circuit, and a second terminal grounded; the second indicator comprises a first terminal connected to the second output terminal of the logic circuit, and a second terminal grounded.

6. The connection system of claim 5, wherein each of the first and second indicators is a light-emitting diode (LED), and the first and second terminals of each of the first and second indicators are an anode and a cathode of the LED.
